(19) United States
(12) Patent Application Publication
(10) Pub. No.: US 2007/0035715 A1
(43) Pub. Date: Feb. 15, 2007

(54) Exposure apparatus for manufacturing semiconductors and method for inspecting pellicles

(75) Inventors: Hyung-Seok Choi, Yongin-si (KR); Yong-Hoon Lee, Suwon-si (KR); Yo-Han Ahn, Yongin-si (KR); Ok-Sun Lee, Suwon-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/502,400

(22) Filed: Aug. 11, 2006

(30) Foreign Application Priority Data
Aug. 11, 2005 (KR) 10-2005-0073884

(51) Int. Cl. G03B 27/62

(52) U.S. Cl. 355/75; 430/5

(57) ABSTRACT

Example embodiments of the present invention relate to an apparatus for manufacturing semiconductors and a method of inspecting a pellicle. Other example embodiments of the present invention relate to an exposure apparatus for manufacturing semiconductors. The apparatus may include a reticle, a pellicle and a reticle chuck. The reticle may be mounted on an upper surface of the reticle chuck and the pellicle may be attached to a lower surface of the reticle chuck so that the pellicle may be detached again. There may be an empty space formed between the pellicle and the reticle. The reticle chuck may include holes for supplying or exhausting a purging gas from the empty space. Because a simpler yet more efficient purging system may be installed to the reticle chuck, an effective measure may be provided against contaminations on the pattern surface of the reticle.

### PRIORITY STATEMENT

This U.S. non-provisional patent application claims priority under 35 U.S.C. § 119 to Korean Patent Application No. 2005-73884, filed on Aug. 11, 2005, in the Korean Intellectual Property Office (KIPO), the entire contents of which are incorporated herein by reference.

### BACKGROUND

1. Field

Example embodiments of the present invention relate to an apparatus for manufacturing semiconductors and a method of inspecting a pellicle. Other example embodiments of the present invention relate to an exposure apparatus for manufacturing semiconductors.

2. Discussion of the Related Art

A reticle may be important in a photo process for manufacturing semiconductors. The reticle may be used as a mask in the photo process for replicating a pattern on a wafer coated with a photoresist layer. The reticle may contain the pattern to be replicated to the wafer. When contaminations are accumulated or particles are deposited on a surface forming the pattern in the reticle, it may cause a defect to the pattern that is replicated to the wafer. In order to prevent the possible deposition of the particles, a pellicle may be used as an organic protection film to cover the pattern surface of the reticle.

FIG. 1 is a diagram illustrating a conventional reticle stage in an exposure apparatus of manufacturing semiconductors, and FIG. 2 is a graph illustrating a tendency of haze occurrences as exposures accumulated. Referring to FIG. 1, the conventional reticle stage 10 may include a reticle chuck 11 on which a reticle 12 is mounted. A pellicle 15 may be attached to the reticle 12 to protect the pattern formed on the reticle 12. The pellicle 15 may include a pellicle frame 13 and a pellicle membrane 14. The pellicle membrane 14 may be attached to the pellicle frame 13. A haze (e.g., a defect that grows) may occur on the pattern surface of the reticle 12 while manufacturing semiconductors in a FAB, and therefore, it is more important to maintain clean manufacturing environments.

FIG. 2 is a graph illustrating the haze occurrence of the conventional art in the reticle according to exposure accumulated. The haze that occurs in the reticle may increase more drastically after the accumulated exposure reaches a certain point, as shown in FIG. 2. The reticle may be cleaned when the haze begins to increase more sharply. The pellicle may be replaced at this point. Referring to FIG. 1, the pellicle 15 may be attached to the reticle 12. The pellicle 15, which is attached to the reticle 12 by adhesives, may be detached for the cleaning of the reticle 12. The pellicle 15 may protect the pattern of the reticle 12. A human worker may detach the pellicle 15 manually after the reticle is heated such that the adhesive force is weakened. The pellicle membrane 14 (e.g., relatively thin, about 800 nm) may be more easily broken during the detachment work, and so may not be used again. The pellicle may be discarded every time when the reticle is cleaned. As semiconductor production grows, and factors causing the haze problems (e.g., increase of energy of exposure light and/or the like) increase, the maintenance period of the reticle may shorten and increase the consumption of the pellicles.

In order to alleviate this problem, a purging system may be installed in a space between the reticle 12 and the pellicle 15 for cleanliness. To install the purging system in the space between the reticle 12 and the pellicle 15, holes and tubes may need to be installed on the pellicle frame 13 for purging. The reticle 12 may be more solidly attached to the pellicle 15 by adhesives as illustrated in FIG. 1, so that the pellicle 15 may be loaded to the reticle stage 10 together with the reticle 12. Installing the purging system may be practically more difficult as proposed. A purging system may be needed that is more useful and relatively easier to install. The purging system may need to keep the space between the reticle 12 and the pellicle 15 cleaner.

### SUMMARY

Example embodiments of the present invention relate to an apparatus for manufacturing semiconductors and a method of inspecting a pellicle. Other example embodiments of the present invention relate to an exposure apparatus for manufacturing semiconductors. Example embodiments of the present invention provide an exposure apparatus for manufacturing semiconductors, wherein the pellicle may not be attached to the reticle such that the pellicle may be used for the natural lifespan of the pellicle.

According to example embodiments of the present invention, the exposure apparatus may include a reticle and a reticle chuck. The reticle may be mounted on an upper surface of the reticle chuck and the reticle chuck may include a pellicle attached to a lower surface of the reticle chuck so that the pellicle may be detached again. There may be an empty space formed between the pellicle and the reticle. The reticle chuck may include holes for supplying a purging gas into or out of the empty space.

According to example embodiments of the present invention, the holes may include an inlet and an outlet. The inlet may be for supplying the purging gas into the empty space, while the outlet may be for exhausting the purging gas from the empty space. The exposure apparatus may further include a first line that is connected to the inlet and a second line that is connected to the outlet. The first line may be for supplying the purging gas into the empty space, while the second line may be for exhausting the purging gas from the empty space. The exposure apparatus may further include a controller along the first line. The controller may be for controlling the flow rate of the purging gas supplied to the empty space. The exposure apparatus may further include a pump along the second line. The pump may be for exhausting the purging gas from the empty space. The exposure apparatus may further include a filter between the inlet and the first line.

According to example embodiments of the present invention, the exposure apparatus may further include a sensor for measuring light transmittance of the pellicle. The sensor may include a light emitter for irradiating ultraviolet light on to the pellicle and a light receptor for detecting the ultraviolet light transmitted through the pellicle. According to example embodiments of the present invention, the exposure apparatus may further include a pellicle cartridge for storing a plurality of pellicles for replacement. According to example embodiments of the present invention, the pellicle may be mounted on a moving part, so that the pellicle may be more freely attached to or detached from the reticle chuck.

According to example embodiments of the present invention, the exposure system for manufacturing semiconductors may include a wafer stage for mounting a wafer, a reticle stage, a projection optical system for projecting the pattern of the reticle to the wafer, an illumination optical system for irradiating light to the reticle, a purging system for purging the empty space between the reticle and the pellicle by supplying the purging gas through the holes in the reticle chuck and a sensing system for measuring light transmittance of the pellicle. The reticle stage may include a reticle chuck that includes a hole for mounting the reticle containing a pattern projected to the wafer and a moving part for mounting the pellicle to protect the pattern of the reticle. The pellicle may be removably attached to the reticle chuck.

The purging system may include the supply line for supplying the purging gas into the empty space, the exhaust line for exhausting the purging gas from the empty space, the controller for controlling the flow rate of the purging gas supplied to the empty space along the supply line and the pump for exhausting the purging gas from the empty space along the exhaust line. The exposure system may further include the filter along the supply line. The filter may filter chemicals, particles or both. The purging gas may be made up of gases which are selected from clean air, nitrogen, inert gas, or any combination of the former gases. The sensing system may include an UV spectrophotometer. The exposure system may further include a pellicle cartridge for storing a plurality of pellicles for replacement.

Example embodiments of the present invention also provide a method for inspecting a pellicle including a reticle that is mounted on an upper surface of a reticle chuck and a pellicle that is separated from the reticle and attached to a lower surface of the reticle chuck in a way that the pellicle may be detached again. The method of example embodiments of the present invention may include exposing the wafer by irradiating light onto the reticle, purging an empty space between the reticle and the pellicle, detaching the reticle from the reticle chuck, cleaning the reticle, detaching the pellicle from the reticle chuck, measuring light transmittance of the pellicle to obtain a light transmittance result, reattaching the pellicle when the light transmittance result of the pellicle is above or equal to a certain threshold and replacing the pellicle when the light transmittance result is below a threshold. The measuring of a light transmittance of the pellicle may include scanning a pellicle membrane of the pellicle using an UV spectrophotometer.

Purging the empty space with a purging gas may be selected from clean air, nitrogen, inert gas, or any combination of the former gases. Detaching the pellicle from the reticle chuck may include using a moving part that is also for mounting the pellicle. According to example embodiments of the present invention, the reticle may be used while the pellicle is not attached to the reticle, and particles on the pattern surface of the reticle may be removed through purging while the pellicle is installed on the reticle stage. Only the reticle may be cleaned while the pellicle remains installed on the reticle stage, and so, the pellicle may be used for its natural lifespan, thereby increasing or maximizing the efficiency of usage.

### BRIEF DESCRIPTION OF THE DRAWINGS

Example embodiments of the present invention will be more clearly understood from the following detailed description taken in conjunction with the accompanying drawings. FIGS. 1-6 represent non-limiting, example embodiments of the present invention as described herein.

FIG. 1 is a diagram illustrating a reticle stage in an exposure apparatus for manufacturing semiconductors according to a conventional art;

FIG. 2 is a graph illustrating occurrences of haze versus number of exposed wafers in a reticle stage of a conventional art;

FIG. 3 is a diagram illustrating an exposure apparatus for manufacturing semiconductors according to example embodiments of the present invention;

FIG. 4 is a diagram illustrating a reticle stage in an exposure system for manufacturing semiconductors according to example embodiments of the present invention;

FIG. 5 is a diagram illustrating a monitoring operation of a pellicle of a reticle stage in an exposure system for manufacturing semiconductors according to example embodiments of the present invention; and

FIG. 6 is a flow chart illustrating a method for inspecting a pellicle according to example embodiments of the present invention.

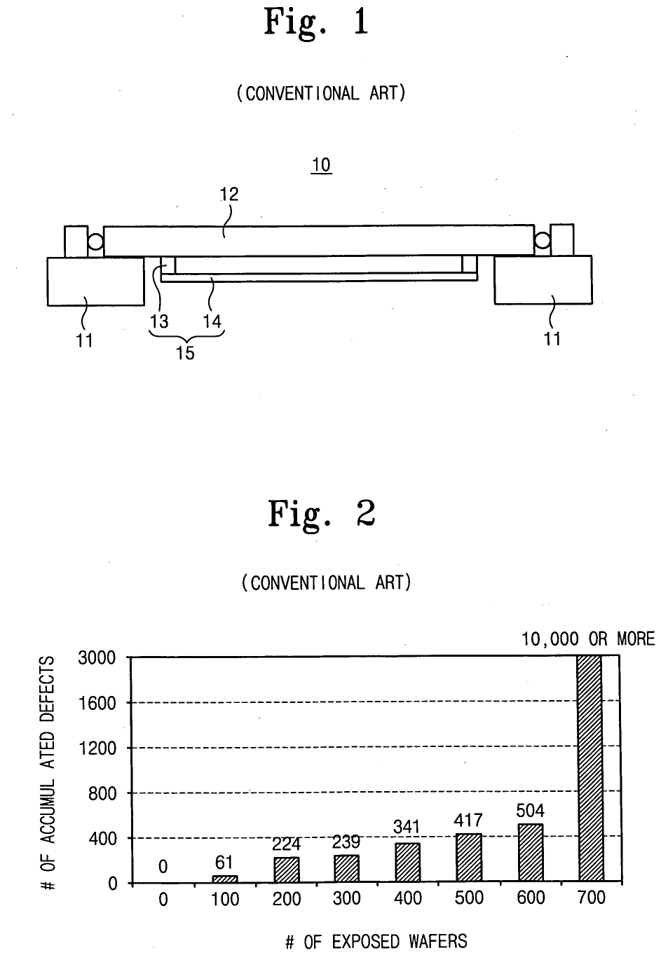

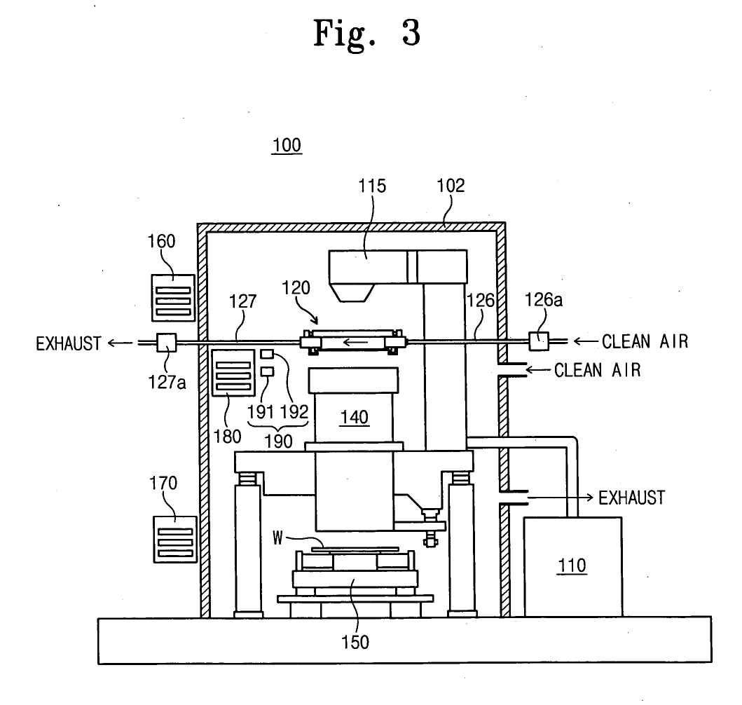

### DESCRIPTION OF THE EXAMPLE EMBODIMENTS OF THE PRESENT INVENTION

Various example embodiments of the present invention are described more fully hereinafter with reference to the accompanying drawings, in which example embodiments of the present invention are shown. Example embodiments of the present invention may, however, be embodied in many different forms and should not be construed as limited to the example embodiments set forth herein. Rather, these embodiments are provided so that this disclosure will be thorough and complete, and will fully convey the scope of example embodiments of the present invention to those skilled in the art. In the drawings, the sizes and relative sizes of layers and regions may be exaggerated for clarity.

It will be understood that when an element or layer is referred to as being “on”, “connected to” or “coupled to” another element or layer, it may be directly on, connected or coupled to the other element or layer or intervening elements or layers may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. A first element, component, region, layer or section discussed below could be termed a second element, component, region, layer or section without departing from the teachings of the example embodiments of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. The exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the example embodiments of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments of the present invention belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Example embodiments of the present invention relate to an apparatus for manufacturing semiconductors and a method of inspecting a pellicle. Other example embodiments of the present invention relate to an exposure apparatus for manufacturing semiconductors.

FIG. 3 is a diagram illustrating an exposure apparatus for manufacturing semiconductors according to example embodiments of the present invention. Referring to FIG. 3, the exposure apparatus 100 may include a wafer stage 150 that contains a wafer (W) to be exposed in a housing 102 and moves the wafer (W) in an up-and-down, right-and-left, slanted or rotational direction. The exposure apparatus 100 may also include a reticle stage 120 on which a reticle containing a pattern to be projected to the wafer (W) is mounted. The exposure apparatus 100 may also include a projection optical system 140 for projecting the pattern of the reticle to the wafer (W) and an illumination optical system 115 for irradiating a light that is generated from a light source 110 to the reticle.

Clean air may be introduced into the housing 102 in order to maintain a clean environment inside of the exposure apparatus 100. The exposure apparatus 100 may further include a reticle loadlock chamber 160 for transferring the reticle to the reticle stage 120 and a wafer loadlock chamber 170 for transferring the wafer (W) to the wafer stage 150. The light source 110 may be i-line (e.g., a wavelength of about 365 nm), a KrF excimer laser of about 248 nm, an ArF excimer laser of about 193 nm or an F2 excimer laser of about 157 nm. The light source 110 that generates light of relatively shorter wavelengths (e.g., ArF excimer laser or F2 excimer laser that generates ultraviolet rays) may provide an improved resolution, thereby satisfying requirements for higher level of integration of semiconductor devises.

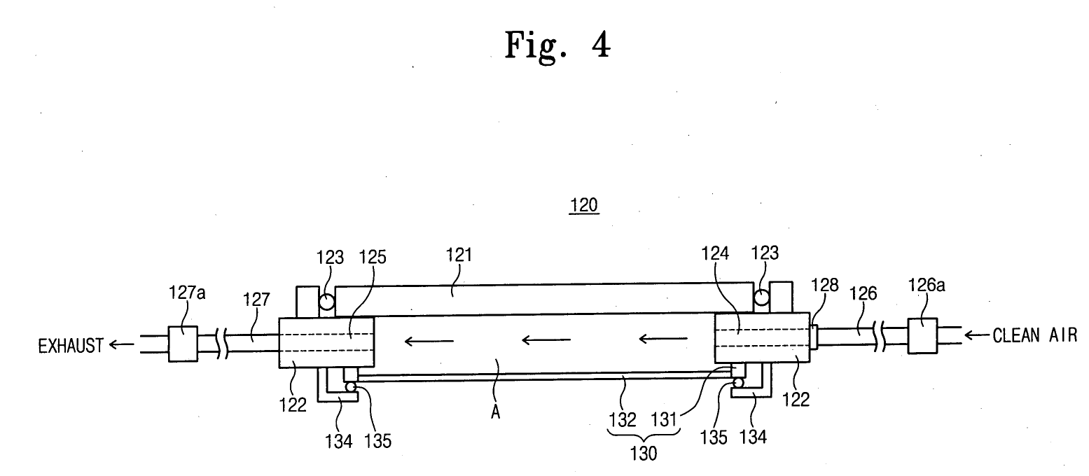

FIG. 4 is a diagram illustrating a reticle stage in an exposure system for manufacturing semiconductors according to example embodiments of the present invention. Referring to FIG. 4, the reticle stage 120 may include a reticle chuck 122 on which a reticle 121 containing a specific pattern is mounted. The reticle chuck 122 may include guides 123 that are in contact with a side of the reticle 121 and are for mounting the reticle 121 properly and firmly on the reticle chuck 122. A pellicle 130 may be attached to a lower surface of the reticle chuck 122 so that the pellicle 130 can be detached again. The pellicle 130 may not be attached to the reticle chuck 122 by adhesives.

The pellicle 130 may not be solidly attached to the lower surface of the reticle chuck 122. The pellicle 130 may be mounted on a moving part 134 and may be attached to or detached from the lower surface of the reticle chuck 122. The pellicle 130 may include a pellicle membrane 132 of which light transmittance is about 100% and a pellicle frame 131 for supporting the pellicle membrane 132. The pellicle membrane 132 may not be damaged by friction while the pellicle 130 is mounted by the moving part 134. The moving part 134 may include a pellicle supporter 135 for upholding the pellicle frame 131. The pellicle membrane 132 may be attached to the pellicle frame 131 in a way that the pellicle membrane 132 is not in direct contact with the pellicle supporter 135.

When the reticle 121 is mounted on the reticle chuck 122 and the pellicle 130 is attached on the bottom surface of the reticle chuck 122, an empty space (A) may form between the reticle 121 and the pellicle 130. In order to improve the reliability of an exposure process, the empty space (A) may be filled with a flow of gases which are selected from clean air, nitrogen, inert gas and/or any combination of the former gases. The empty space (A) may become cleaner by lowering possible particle deposition on the pattern surface of the reticle 121 and the gas flow may remove particles on the pattern surface of the reticle 121 or particles suspending in the empty space (A). An inlet 124 may be formed on a side of the reticle chuck 122 for supplying the gas, while an outlet 125 may be formed on the other side of the reticle chuck 122. The inlet 124 may be connected to a line 126 for supplying the gas into the empty space (A). The outlet 125 may be connected to a line 127 for exhausting the gas from the empty space (A). A filter 128 may be installed between the line 126 and the inlet 122 for filtering chemicals and/or particles. The filter 128, for example, may have just one filtering function for chemicals and/or particles. The filter 128 also may have a combined filtering function for both chemicals and particles.

When an undesired amount of the gas is supplied into the empty space (A) and a pressure of the empty space (A) is higher than that of inside the apparatus 100, or conversely the pressure of the empty space (A) is lower than that of the apparatus 100, then the pellicle membrane 132 may be inflated or depressed. An air controller 126a may be installed in the line 126 for controlling a flow rate of the gas supplied into the empty space (A). A pump 127a may be installed in the line 127 so that the flow of gas into or away from the empty space (A) may be more sufficient and smoother. The reticle stage 120 described as above operates as follows.

Organic pollutants may arise in an ArF exposure apparatus that carries out a critical process for manufacturing a VLSI memory chip of a design rule lower than about 100 nm. The material of the pellicle for protecting the pattern surface of the reticle may evaporate. The pellicle in the ArF exposure apparatus may use the exposure lights with energy higher than that of KrF exposure apparatus. The organic pollutants may deposit on the pattern surface of the reticle resulting in the size of the exposed pattern becoming irregular or distorted in the photo process. This may also happen with an F2 exposure apparatus. In order to avoid the undesirable consequences, the clean gas may be supplied to the empty space (A) to make the empty space (A) cleaner or removing the particles sustained in the empty space (A).

With the ArF or F excimer laser as the light source 110, several oxygen absorption bands may exist near each wavelength of the light. In oxygen absorption bands, the oxygen may absorb the light to form ozone. The ozone may accelerate the light absorption, thereby reducing the light transmittance of the pellicle membrane 132. Various products generated by the ozone may also contaminate the reticle 121. By keeping the clean gas flowing through the empty space (A), the oxygen concentration of the empty space (A) may be reduced to a lower level, thereby reducing the possibility of the reticle 121 contamination.

The reticle 121 may be cleaned during maintenance, while the pellicle 130 stays attached to the reticle chuck 122, so that the pellicle 130 may be used for its natural lifespan. Compared with a cleaning period of the reticle 121, the degradation of the pellicle 130 takes place more slowly. Because the reticle 121 and the pellicle 130 are separated from each other in the apparatus 100 of example embodiments of the present invention, it may not be necessary to remove or discard the pellicle 130 for cleaning the reticle 121. The cleaning period may become shorter when the ArF or F2 excimer laser is used as the light source 110. The ArF or F2 excimer laser, with light energy higher than that of the KrF excimer laser, may increase a possibility of the haze occurrence. Example embodiments of the present invention may not remove or discard the pellicle 130 to clean the reticle 121.

Referring to FIG. 3 again, the apparatus 100 may further include a sensor 190 for measuring the degradation of the pellicle 130. The apparatus 100 may further include a pellicle cartridge 180 within the housing 102. The pellicle cartridge 180 may store the pellicles 130 for replacement. The sensor 190, for example, may be a UV spectrophotometer including a light emitter 191 and a light receptor 192. With repetition of the exposure process, the amount of light exposure of the pellicle 130 may accumulate and the light transmittance of the pellicle membrane 132 may decrease. When the accumulated light exposure exceeds a given value (for example, about 50,000,000 mJ), the degradation of the pellicle 130 may be measured and the pellicle 130 may be replaced. The inspection and replacement of the pellicle 130 described as above may be carried out as follows.

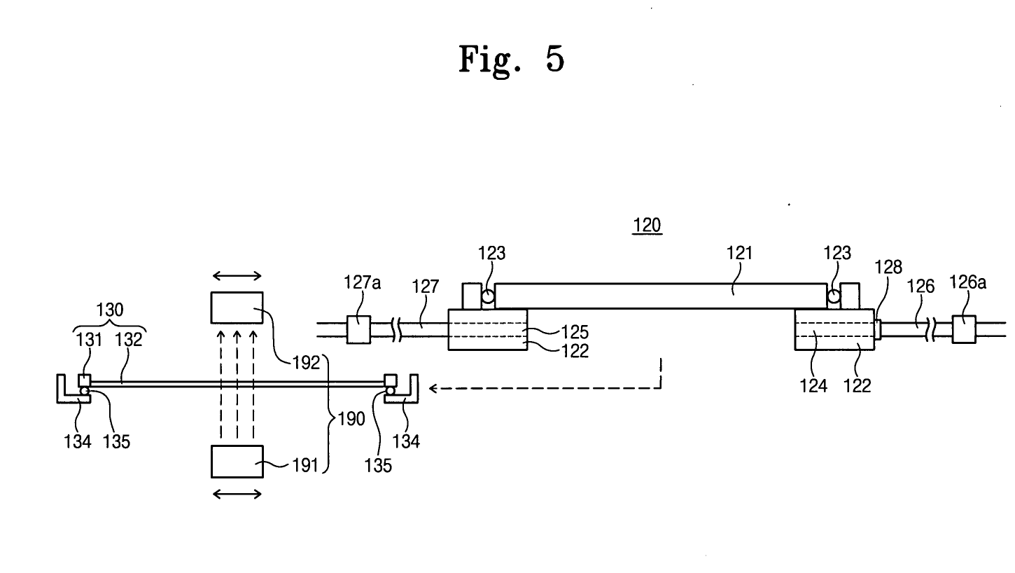

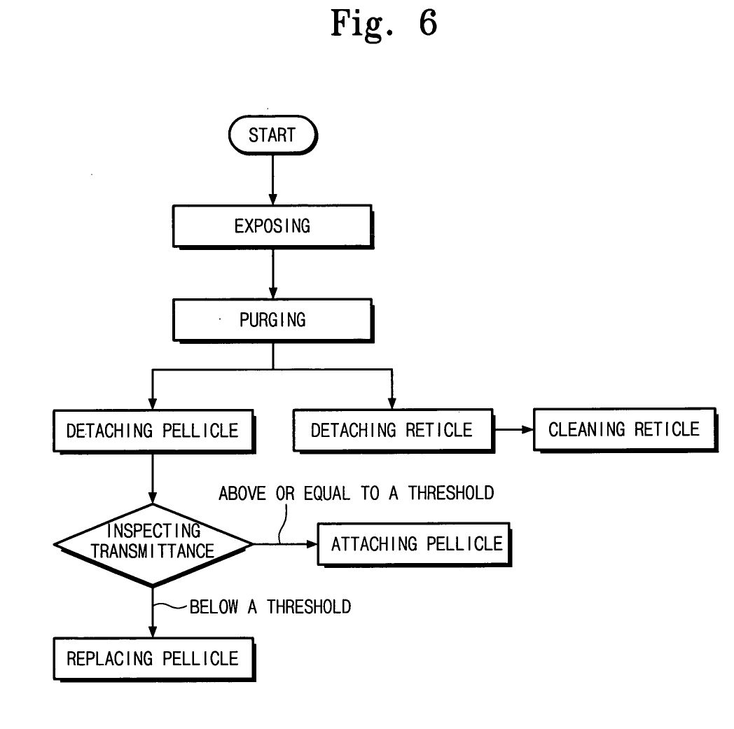

FIG. 5 is a diagram illustrating monitoring operation of the pellicle of the reticle stage according to example embodiments of the present invention, and FIG. 6 is a flow chart illustrating a method for inspecting a pellicle of example embodiments of the present invention. Referring to FIGS. 5 and 6, the reticle 121 may be separated from the reticle chuck 122 and cleaned after the exposure process is carried out for a given period of time. The sensor 190 may measure the degradation of the pellicle 130. When the reticle 121 is separated from the reticle chuck 122 for cleaning, the pellicle 130 may be transferred by the moving part 134 to the sensor 190. After the pellicle 130 is transferred to the sensor 190, the light emitter 191 may emit ultraviolet rays to scan the pellicle membrane 132 and the light receptor 192 may detect the light transmitted through the pellicle membrane 132. The sensor 190 may measure the light transmittance. When the light transmittance is above a threshold (e.g., about 99%), the pellicle 130 may be installed on the reticle chuck 122 again to be used in the exposure process. When the light transmittance is below a threshold (e.g., less than about 99%), the pellicle 130 may be transferred to the pellicle cartridge to be discarded and a new pellicle 130 may be installed to the reticle chuck 122 for the exposure process.

Because the reticle 121 and the pellicle 130 are separated from each other, the inspection and replacement of the pellicle 130 may not need to be done manually, but it may be done based on a real-time monitoring at the time of the reticle 121 replacement. The degree of the degradation of the pellicle 130 may be identified with improved accuracy and the pellicle 130 may be replaced at the right time in the natural lifespan, thereby increasing or maximizing efficiency of the pellicle 130 usage. Setting a clear criterion for timing to inspect the pellicle 130 may be more difficult otherwise. The degradation of the pellicle 130 may take place differently for different exposure processes, so it may be inaccurate to set an inspection period for the pellicle 130 based on the accumulated light exposure.

When the ArF excimer laser is used as the light source 110, the light transmittance of the pellicle 130 may be above about 99% for an accumulated light exposure of about 50,000,000 mJ. The degradation of the pellicle 130, caused by the exposure light, may proceed relatively slowly in a KrF exposure process (e.g., the exposure process using the KrF excimer laser as the light source 110). The KrF exposure process may result in more productivity than that of the ArF exposure process. When the pellicle 130 is replaced based on only the accumulated light exposure, the pellicle 130 may be wasted. In the apparatus where the pellicle 130 is separated from the reticle 121, the degradation of the pellicle 130 may be measured at the time of replacing the reticle 121 and the pellicle 130 may be replaced at a proper time.

Because the reticle 121 is separated from the pellicle 130 according to example embodiments of the present invention, the reticle 121 may be fabricated in a simpler way. The fabrication of the reticle 121, for example, may include mounting the pellicle 130 to the reticle 121, in addition to forming a pattern on the reticle 121. According to example embodiments of the present invention, the fabrication of the reticle 121 may not require mounting the pellicle 130 to the reticle 121. There may be no need for removing or mounting the pellicle 130 or for removing the adhesives.

Although various example embodiments of the present invention have been described in connection with the example embodiments of the present invention illustrated in the accompanying drawings, it is not limited thereto. It will be apparent to those skilled in the art that various substitution, modifications and changes may be thereto without departing from the scope and spirit of example embodiments of the present invention.

What is claimed is:

1. An exposure apparatus for manufacturing semiconductors comprising:
a reticle that is mounted on an upper surface of a reticle chuck; and
a reticle chuck that includes holes for supplying and exhausting a purging gas from an empty space and a pellicle that is removably attached to a lower surface of the reticle chuck, wherein the pellicle is separated from the reticle, forming the empty space between the pellicle and the reticle.

2. The exposure apparatus of claim 1, further comprising:
an inlet for supplying the purging gas into the empty space; and
an outlet for exhausting the purging gas from the empty space.

3. The exposure apparatus of claim 2, further comprising:
a first line that is connected to the inlet, wherein the first line is for supplying the purging gas into the empty space; and
a second line that is connected to the outlet, wherein the second line is for exhausting the purging gas from the empty space.

4. The exposure apparatus of claim 3, further comprising:
a controller along the first line, wherein the controller controls the flow rate of the purging gas supplied to the empty space.

5. The exposure apparatus of claim 3, further comprising:
a pump along the second line, wherein the pump exhausts the purging gas from the empty space.

6. The exposure apparatus of claim 3, further comprising:
a filter between the inlet and the first line.

7. The exposure apparatus of claim 1, further comprising:
a sensor for measuring a light transmittance of the pellicle.

8. The exposure apparatus of claim 7, wherein the sensor includes:
a light emitter for irradiating ultraviolet light on the pellicle; and
a light receptor for detecting the ultraviolet light transmitted through the pellicle.

9. The exposure apparatus of claim 1, further comprising:
a pellicle cartridge for storing a plurality of pellicles for replacement.

10. The exposure apparatus of claim 1, wherein the reticle is mounted on a moving part and is removably attached to the reticle chuck.

11. An exposure system for manufacturing semiconductors, comprising:
a wafer stage for mounting a wafer; and
a reticle stage including:
the exposure apparatus according to claim 1, wherein the reticle contains a pattern to be projected to the wafer;
a moving part for mounting the pellicle to be removably attached to the reticle chuck, wherein the pellicle protects the pattern of the reticle;
a projection optical system for projecting the pattern of the reticle to the wafer;
an illumination optical system for irradiating light onto the reticle;
a purging system for purging the empty space by supplying the purging gas through the holes in the reticle chuck, wherein the empty space is formed between the reticle and the pellicle; and
a sensing system for measuring light transmittance of the pellicle.

12. The exposure system of claim 11, wherein the purging system includes:
a supply line for supplying the purging gas into the empty space;
an exhaust line for exhausting the purging gas from the empty space;
a controller along the supply line, wherein the controller controls the flow of the purging gas supplied to the empty space; and
a pump along the exhaust line, wherein the pump exhausts the purging gas from the empty space.

13. The exposure system of claim 12, further comprising:
a filter capable of filtering at least one of chemicals and particles.

14. The exposure system of claim 12, wherein the purging gas is one selected from the group including clean air, nitrogen, inert gas, and a mixture thereof.

15. The exposure system of claim 11, wherein the sensing system includes an UV spectrophotometer.

16. The exposure system of claim 11, further comprising:
a pellicle cartridge for storing a plurality of pellicles.

17. A method for inspecting a pellicle, the method comprising:
exposing a wafer by irradiating light onto a reticle;
purging an empty space between the reticle and the pellicle;
detaching the reticle from a reticle chuck;
cleaning the reticle;
detaching the pellicle from the reticle chuck;
measuring light transmittance of the pellicle to obtain a light transmittance result;
re-attaching the pellicle to the reticle chuck when the light transmittance result is above or equal to a threshold; and
replacing the pellicle when the light transmittance result is below a threshold.

18. The method of claim 17, wherein measuring a light transmittance of the pellicle includes scanning a pellicle membrane of the pellicle using an UV spectrophotometer.

19. The method of claim 17, wherein purging the empty space includes supplying a purging gas through the empty space and is one selected from the group including clean air, nitrogen, inert gas, and a mixture thereof.

20. The method of claim 17, wherein detaching the pellicle from the reticle chuck includes detaching a moving part on which the pellicle is mounted.
